(19) United States
(12) Patent Application Publication
(10) Pub. No.: US 2015/0086960 A1
(43) Pub. Date: Mar. 26, 2015

(54) GUIDING CONSTRUCTION AND VALIDATION OF ASSESSMENT ITEMS

(71) Applicant: SRI International, Menlo Park, CA (US)

(72) Inventors: Geneva D. Haertel, Los Angeles, CA (US); Terry Vendlinski, Menlo Park, CA (US); Daisy Rutstein, Santa Clara, CA (US); Andrew Salsbury, San Mateo, CA (US); Chris Makler, Palo Alto, CA (US); Patricia Schank, Menlo Park, CA (US); John J. Brecht, San Francisco, CA (US)

(73) Assignee: SRI International, Menlo Park, CA (US)

(21) Appl. No.: 14/167,146

(22) Filed: Jan. 29, 2014

Related U.S. Application Data
(60) Provisional application No. 61/805,682, filed on Mar. 27, 2013.

(51) Int. Cl. G09B 7/06

(52) U.S. Cl. CPC G09B 7/06
USPC 434/322

(57) ABSTRACT

A method for guiding a user in a construction of an assessment item includes identifying a requirement of the assessment item, filtering a plurality of documents in accordance with the requirement to produce a set of relevant documents, presenting a workflow for use in constructing the assessment item, wherein the workflow is based on the set of relevant documents, and presenting a set of questions for use in validating, by the user, that a proposed assessment item meets the requirement.

### FIELD OF THE INVENTION

The present invention relates generally to educational assessment design, and relates more particularly to systems for constructing evidence-centered designed educational assessment items.

### BACKGROUND OF THE DISCLOSURE

An educational assessment is a special kind of evidentiary argument that requires making sense of complex data to draw inferences or conclusions. Specifically, an educational assessment is a way of gathering information (e.g., in the form of particular things that students say, do, or make under particular circumstances) to make inferences about what students know, can do, or have accomplished or learned.

Assessment task designers are often required to use evidence-centered design (ECD) documents as resources for constructing assessment tasks. ECD documents are typically voluminous and contain complex content and associations, making them difficult to work with under the constraints that many designers face (e.g., tight deadlines, requirements for large numbers of tasks, high technical quality standards, etc.). Thus, it is difficult to scale ECD resources in a manner that makes them easily used by writers of assessment items.

### SUMMARY OF THE INVENTION

A method for guiding a user in a construction of an assessment item includes identifying a requirement of the assessment item, filtering a plurality of documents in accordance with the requirement to produce a set of relevant documents, presenting a workflow for use in constructing the assessment item, wherein the workflow is based on the set of relevant documents, and presenting a set of questions for use in validating, by the user, that a proposed assessment item meets the requirement.

A computer readable storage device according to another embodiment of the invention contains an executable program for guiding a user in a construction of an assessment item, wherein when the program is executed, the program causes a processor to performs steps including identifying requirements of the assessment item, filtering a plurality of documents in accordance with the requirements to produce a set of relevant documents, presenting a workflow for use in constructing the assessment item, wherein the workflow is based on the set of relevant documents, and presenting a set of questions for use in validating, by the user, that a proposed assessment item meets the requirement.

A system for guiding a user in a construction of an assessment item includes a database that relates potential assessment targets to potential observations that facilitate evaluation of the potential assessment targets, a processor for filtering data contained in the database in response to an identification of an assessment target and a design choice associated with the assessment item, and a user interface for leading a user through a workflow that incorporates data that is identified as being relevant to a design, creation, and validation of the assessment item based on the filtering.

### BRIEF DESCRIPTION OF THE DRAWINGS

The teachings of the present invention can be readily understood by considering the following detailed description in conjunction with the accompanying drawings, in which:

FIG. 1 is a diagram illustrating one embodiment of a system for guiding the construction and validation of assessment items, according to the present invention;

FIG. 2 is a flow diagram illustrating one embodiment of a method for guiding the construction of an assessment item, according to the present invention;

FIG. 3 illustrates an exemplary user interface that may be presented to an item writer in order to identify the requirements of the assessment item; and

FIG. 4 is a high level block diagram of the present invention that is implemented using a general purpose computing device.

To facilitate understanding, identical reference numerals have sometimes been used to designate elements common to multiple figures.

### DETAILED DESCRIPTION

The present invention relates to a method and apparatus (e.g., a “wizard”) for guiding the construction and validation of assessment items. Embodiments of the invention filter and organize relevant evidence-centered design (ECD) documentation into a streamlined guide that task designers can use when developing assessment items. The guide includes an ordered sequence of questions that directs the writer of an assessment item through the development process by simplifying complex associations within the ECD documentation and by posing reflective questions that are intended to improve the technical quality of the resulting assessment item.

Within the context of the present invention, an “assessment item” is a article (e.g., a question) that is designed to gather information useful in evaluating a student's knowledge, skill, or ability (i.e., what he knows, can do, or has accomplished or learned). A series of assessment items is referred to as an “assessment task.” An “assessment target” refers to a collection of standards, task models, or constructs related to particular knowledge, skills, or abilities possessed by the student and about which the assessment item is designed to gather evidence.

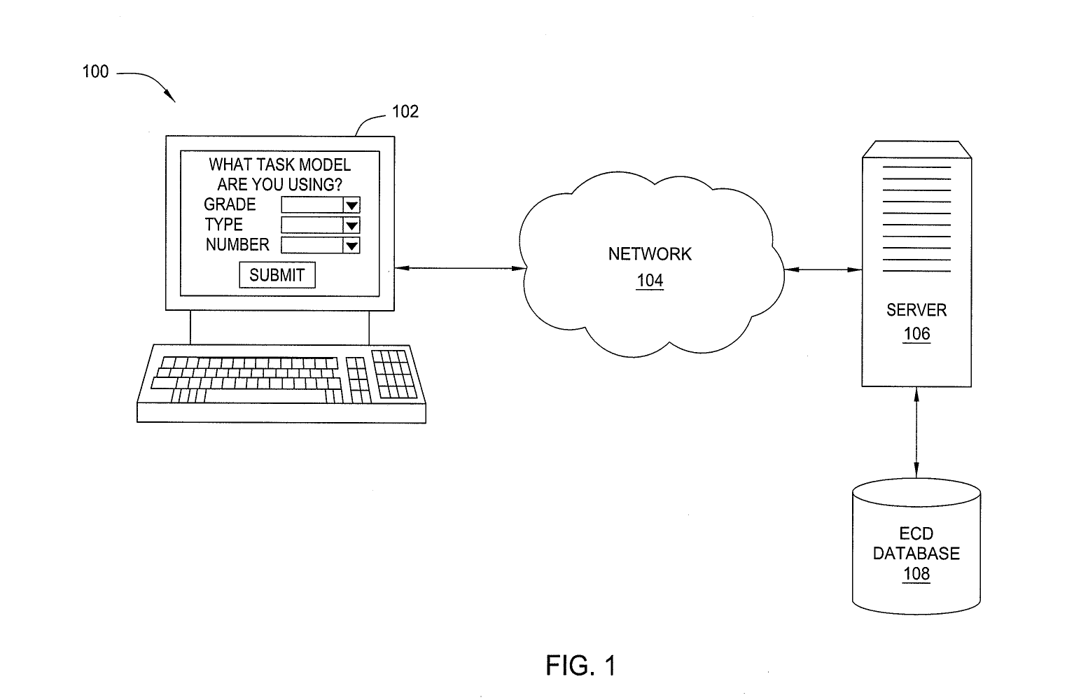

FIG. 1 is a diagram illustrating one embodiment of a system 100 for guiding the construction and validation of assessment items, according to the present invention. As illustrated, the system 100 generally comprises a user endpoint device 102 connected over a network 104 to a server 106. In addition, the server 106 has access to a database 108.

The user endpoint device 102 may be any type of endpoint device such as a desktop computer or a mobile endpoint device such as a cellular telephone, a smart phone, a tablet computer, a laptop computer, a netbook, an ultrabook, a portable media device (e.g., an MP3 player), a gaming console, a portable gaming device, or the like. It should be noted that although only one user endpoint device 102 is illustrated in FIG. 1, any number of user endpoint devices may be deployed. The user endpoint device 102 presents a user interface (UI) that leads the user through a workflow that incorporates data that is determined to be relevant to the design, creation, and validation of an assessment item.

The network 104 may be any type of communications network, such as for example, an Internet Protocol (IP) network (e.g., an IP Multimedia Subsystem (IMS) network, an asynchronous transfer mode (ATM) network, a wireless network, a cellular network (e.g., 2G, 3G, and the like), a long term evolution (LTE) network, and the like). It should be noted that an IP network is broadly defined as a network that uses Internet Protocol to exchange data packets. Additional exemplary IP networks include Voice over IP (VoIP) networks, Service over IP (SoIP) networks, and the like.

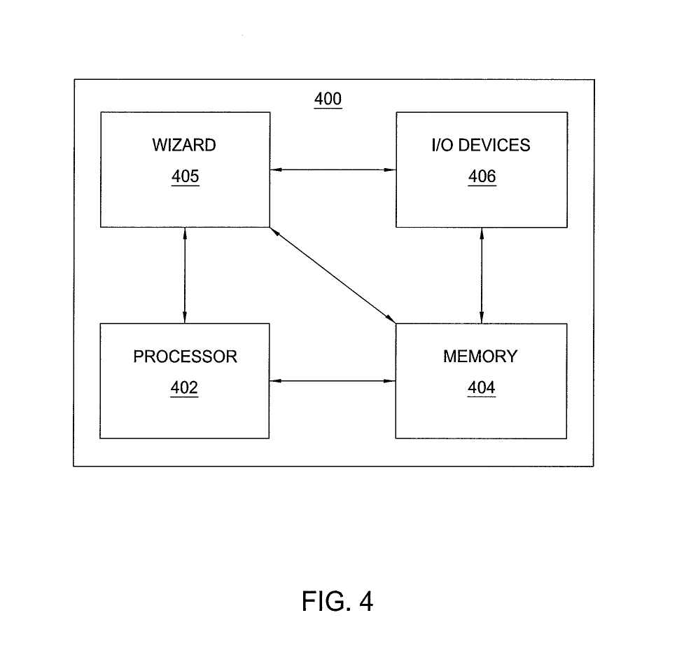

In one embodiment, the server 106 is an application server that hosts an application (e.g., a “wizard”) for guiding the construction and validation of assessment items. This application is a separate application from that in which the writer actually creates the assessment item. The server 106 may comprise a general purpose computer as illustrated in FIG. 4 and discussed below. In one embodiment, the server 106 may perform the methods and algorithms discussed below related to guiding the construction and validation of assessment items. For instance, the server 106 may filter data contained in the database in response to the identification of an assessment target and a design choice associated with the assessment item.

The database 108 is a repository for evidence-centered design (ECD) documentation. In one embodiment, the database 108 is a relational database that relates potential assessment targets to potential observations that facilitate their evaluation (e.g., an assessment target concerning fractions is related to one or more observations that allow one to determine whether a student has mastered fractions). In a further embodiment, the data contained in the database is customized for an entity with whom the writer of the assessment item is associated. In addition, the database 108 may contain state variables for users of the system 100. Although only a single database 108 is illustrated, it will be appreciated that the system may include multiple databases (e.g., discrete databases for relational data and state variables).

FIG. 1 illustrates only one possible configuration for the system 100. In alternative embodiments, the application for guiding the construction and validation of assessment items may execute directly on the user endpoint device 102, thereby obviating the need for the server 106. In this case, the user endpoint device 102 would have direct access to the database 108. Alternatively, the application for guiding the construction and validation of assessment items may be distributed over multiple servers.

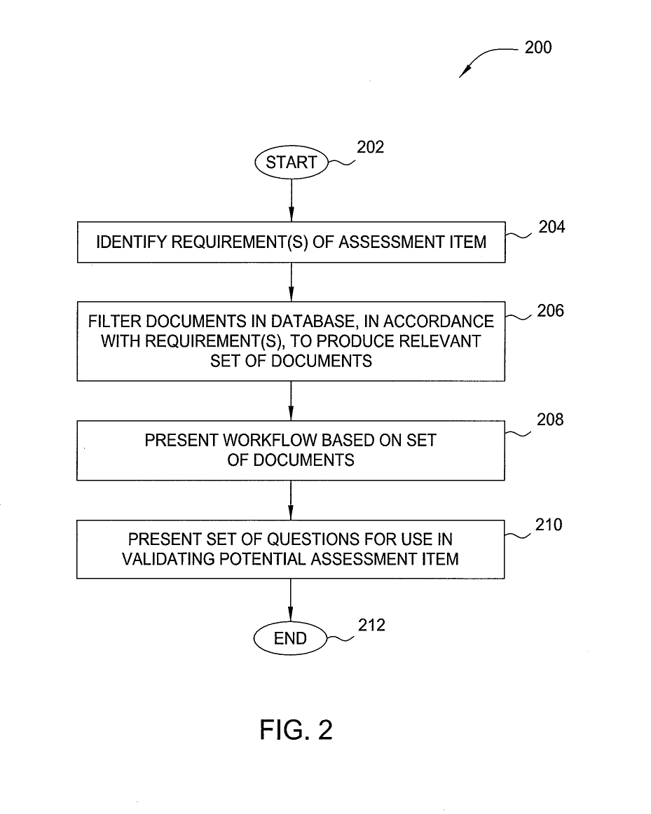

FIG. 2 is a flow diagram illustrating one embodiment of a method 200 for guiding the construction of an assessment item, according to the present invention. The method 200 may be implemented, for example by the system 100 illustrated in FIG. 1. As such, reference is made in the discussion of the method 200 to various components of the system 100. Such reference is made for illustrative purposes only, however, and does not in any way limit execution of the method 200 to a particular system or architecture.

The method 200 begins in step 202. In step 204, the server 106 identifies a requirement of the assessment item. The requirement may comprise, for example, an assessment target (e.g., a particular item of knowledge, skill, or ability) about which the assessment is intended to gather evidence. Alternatively or in addition, the requirement may comprise a design choice associated with the assessment item (e.g., the format of the assessment item (multiple choice, true/false, open ended, etc.), a rubric for use in evaluating a response to the assessment item, a resource to be used in connection with responding to the assessment item (a passage of text, an image, etc.), or a grade or age level to which the assessment item is targeted). Multiple requirements may be identified in step 204.

In one embodiment, the requirement is identified explicitly by the writer of the assessment item (who is not necessarily the assessment designer), via the user interface on the user endpoint device 102. For instance, the user interface may present a list of potential assessment targets to the writer, and the server 106 may subsequently receive a signal from the user endpoint device 102 indicating that the writer has selected an assessment target from the list.

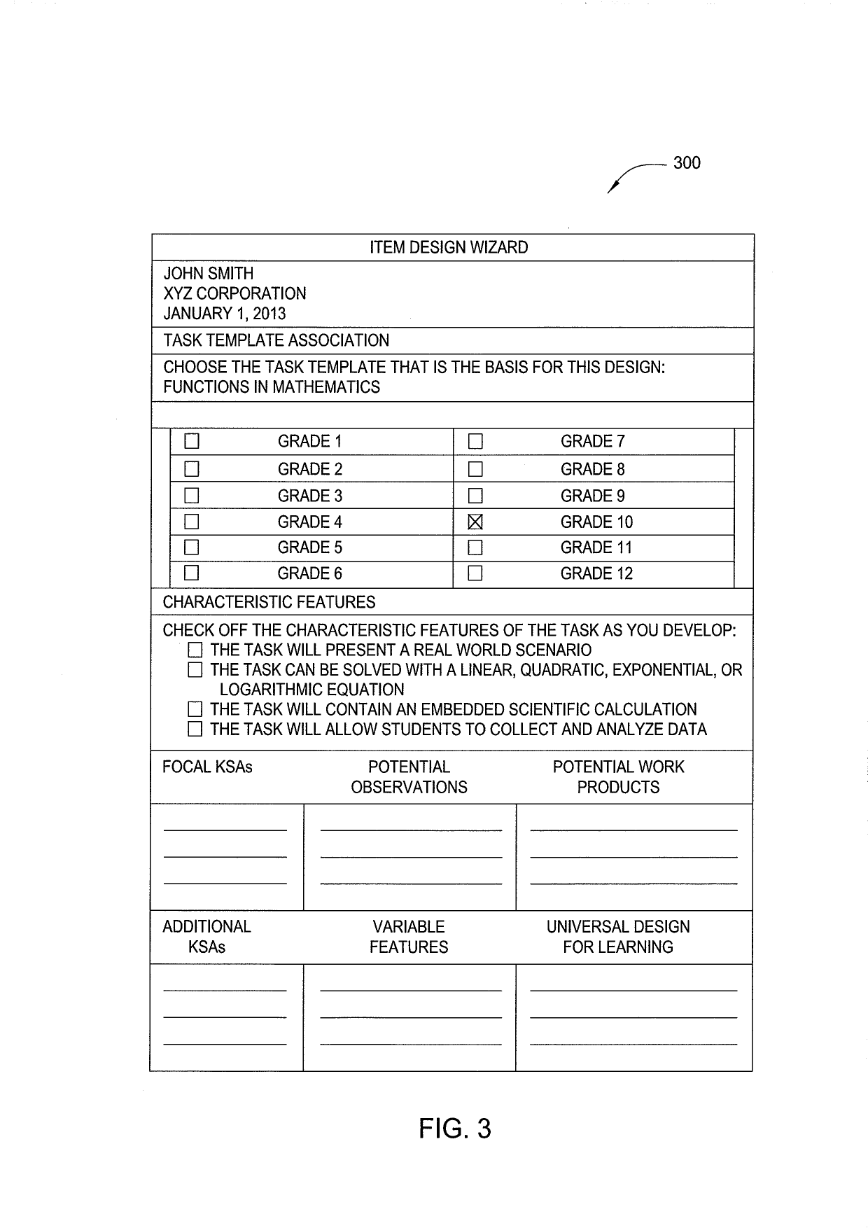

For instance, step 204 may be embodied in a drill-down process that starts by assuming that the writer of the assessment item has been provided with an assignment that corresponds to a particular task model. The writer may enter this task model via the user interface in order to be presented with the number and types of assessment items that are required. In one embodiment, the user interface may display each potential assessment item with a hyperlink that may be clicked for further information (e.g., a list of focal knowledge, skills, or abilities that may be selected). FIG. 3, for instance, illustrates an exemplary user interface 300 that may be presented to an item writer in order to identify the requirements of the assessment item.

In step 206, the server 106 filters the documents in the database 108, in accordance with the identified requirement, in order to produce a set of documents that is relevant to the requirement. For instance, based on the selection of a particular knowledge, skill, or ability, the server 106 may identify a set of potential observations that facilitate evaluation of the selected knowledge, skill, or ability. The documents may include characteristic features (e.g., types of tasks, response options, particular text to be included) of items or tasks designed to assess the selected knowledge, skill, or ability.

In step 208, the user interface presents a workflow for use in constructing the assessment item, where the workflow is based on the set of documents produced in step 206. In one embodiment, the workflow comprises an ordered sequence of prompts relating to the requirement identified in step 204. A prompt may focus the item writer's attention to elements of a potential assessment item, and may be presented as a question and a set of corresponding response options. In a further embodiment, the workflow is based on a stored set of assessment targets and associated instructions created by an individual (e.g., an assessment designer) who is responsible for setting an overall coverage goal for the assessment item. The workflow may be based on evidence-centered design principles. Using this workflow as a guide, the writer may develop a potential assessment item in a separate application.

In step 210, the user interface presents a set of questions for use in validating that a potential assessment item proposed by the designer will meet the requirement identified in step 204. The writer of the assessment item will review the potential assessment item, using the set of questions as a guide to verify that the potential assessment item is appropriate. For instance, the set of questions may ask the writer to confirm that the criteria of certain prompts presented in the workflow in step 208 are met. It is noted that the set of questions alone is typically not enough to entirely validate the potential assessment item, but review of the potential assessment item in accordance with the set of questions is part of the validation process.

The method 200 ends in step 212.

It should be noted that although not explicitly specified, one or more steps of the methods described herein may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in the accompanying Figures that recite a determining operation or involve a decision, do not necessarily require that both branches of the determining operation be practiced. In other words, one of the branches of the determining operation can be deemed as an optional step. In addition, unless stated otherwise, the steps of the methods described herein do not necessarily need to be performed in the order illustrated in the Figures. For instance, some of the described steps may be performed in parallel (e.g., substantially simultaneously), even though they may be illustrated in an ordered sequence.

FIG. 4 is a high level block diagram of the present invention that is implemented using a general purpose computing device 400. The general purpose computing device 400 may, for example, generally comprise elements of the user endpoint device 102 described above. Alternatively, the general purpose computing device 400 may generally comprise elements of the sever 106. In one embodiment, a general purpose computing device 400 comprises a processor 402, a memory 404, a wizard module 405 and various input/output (I/O) devices 406 such as a display (which may or may not be a touch screen display), a keyboard or keypad, a network interface card (NIC), or the like. In one embodiment, at least one I/O device is a storage device (e.g., a disk drive, an optical disk drive, a floppy disk drive). It should be understood that the wizard module 405 can be implemented as a physical device or subsystem that is coupled to the processor 402 through a communication channel.

Alternatively, the wizard module 405 can be represented by one or more software applications (or even a combination of software and hardware, e.g., using Application Specific Integrated Circuits (ASIC)), where the software is loaded from a storage medium (e.g., I/O devices 406) and operated by the processor 402 in the memory 404 of the general purpose computing device 400. Thus, in one embodiment, the wizard module 405 for guiding the construction and validation of assessment items described herein with reference to the preceding Figures can be stored on a non-transitory or tangible computer readable medium or carrier (e.g., RAM, magnetic or optical drive or diskette, and the like).

Although various embodiments which incorporate the teachings of the present invention have been shown and described in detail herein, those skilled in the art can readily devise many other varied embodiments that still incorporate these teachings.

What is claimed is:

1. A method for guiding a user in a construction of an assessment item, the method comprising:
identifying a requirement of the assessment item;
filtering a plurality of documents in accordance with the requirement to produce a set of relevant documents;
presenting a workflow for use in constructing the assessment item, wherein the workflow is based on the set of relevant documents; and
presenting a set of questions for use in validating, by the user, that a proposed assessment item meets the requirement.

2. The method of claim 1, wherein the requirement is an assessment target about which the assessment item is intended to gather evidence.

3. The method of claim 2, wherein the assessment target is a collection of standards, task models, or constructs related to knowledge, skills, or abilities possessed by an individual to whom the assessment item is to be presented.

4. The method of claim 2, wherein the identifying comprises:
presenting a list of potential assessment targets; and
receiving a signal from the user indicating a selection of the assessment target from among the list of potential assessment targets.

5. The method of claim 1, wherein the requirement is a design choice associated with the assessment item.

6. The method of claim 5, wherein the design choice is a format of the assessment item.

7. The method of claim 5, wherein the design choice is a rubric for use in evaluating a response to the assessment item.

8. The method of claim 5, wherein the design choice is a resource to be used in connection with responding to the assessment item.

9. The method of claim 5, wherein the design choice is a grade level to which the assessment item is targeted.

10. The method of claim 1, wherein the workflow comprises an ordered sequence of prompts relating to the requirement.

11. The method of claim 1, wherein the plurality of documents is maintained in a database that relates potential assessment targets to potential observations that facilitate measurement of the potential assessment targets.

12. The method of claim 11, wherein the database contains data that is customized for an entity with whom the user is associated.

13. The method of claim 1, wherein the workflow is based on evidence-centered design principles.

14. The method of claim 1, wherein the workflow is based on a stored set of assessment targets and associated instructions created by an assessment designer responsible for setting an overall coverage goal of the assessment item.

15. A computer readable storage device containing an executable program for guiding a user in a construction of an assessment item, wherein when the program is executed, the program causes a processor to performs steps of:
identifying a requirement of the assessment item;
filtering a plurality of documents in accordance with the requirement to produce a set of relevant documents;
presenting a workflow for use in constructing the assessment item, wherein the workflow is based on the set of relevant documents; and presenting a set of questions for use in validating, by the user, that a proposed assessment item meets the requirement.

16. The computer readable storage device of claim 15, wherein the requirement is an assessment target about which the assessment item is intended to gather evidence.

17. The computer readable storage device of claim 15, wherein the requirement is a design choice associated with the assessment item.

18. A system for guiding a user in a construction of an assessment item, the method comprising:
a database that relates potential assessment targets to potential observations that facilitate measurement of the potential assessment targets;
a processor for filtering data contained in the database in response to an identification of an assessment target and a design choice associated with the assessment item; and
a user interface for leading a user through a workflow that incorporates data that is identified as being relevant to a design, creation, and review of the assessment item based on the filtering.

19. The system of claim 18, wherein the database stores a plurality of evidence-centered design documents.

20. The system of claim 18, wherein the processor and the user interface are components of a common user endpoint device.
